(19) United States
(12) Patent Application Publication
(10) Pub. No.: US 2025/0273826 A1
(43) Pub. Date: Aug. 28, 2025

(54) RIVET TERMINAL, SECONDARY BATTERY INCLUDING RIVET TERMINAL, AND METHOD OF MANUFACTURING SECONDARY BATTERY

(71) Applicant: SAMSUNG SDI CO., LTD., Yongin-si (KR)

(72) Inventors: Myungha Jeong, Yongin-si (KR); Hyun soo Lee, Yongin-si (KR); Keeyun Kim, Yongin-si (KR); Youngjin Hwang, Yongin-si (KR)

(21) Appl. No.: 18/777,437

(22) Filed: Jul. 18, 2024

(30) Foreign Application Priority Data
Feb. 22, 2024 (KR) 10-2024-0026084

(51) Int. Cl. H01M 50/55; H01M 10/0587; H01M 50/103; H01M 50/176; H01M 50/342; H01M 50/567

(52) U.S. Cl. CPC H01M 50/55; H01M 10/0587; H01M 50/103; H01M 50/176; H01M 50/3425; H01M 50/567; H01M 2220/20

(57) ABSTRACT

A rivet terminal includes: a current carrying part connected to a terminal part of a secondary battery and configured to electrically connect a terminal plate of the secondary battery and a current collector within the secondary battery and having a cavity formed therein; and a vent part in the cavity within the current carrying part and configured to be ruptured to enable a gas within the secondary battery to be released.

### CROSS-REFERENCE TO RELATED APPLICATION

The present application claims priority to and the benefit of Korean Patent Application No. 10-2024-0026084, filed on Feb. 22, 2024, in the Korean Intellectual Property Office, the entire disclosure of which is incorporated herein by reference.

### BACKGROUND

### 1. Field

Aspects of some embodiments relate to a rivet terminal, a secondary battery including a rivet terminal, and a method of manufacturing a secondary battery.

### 2. Description of the Related Art

Unlike primary batteries that are not designed to be charged, secondary batteries are designed to be repeatedly discharged and recharged. Low-capacity secondary batteries may be used, for example, in small portable electronic devices, such as smart phones, feature phones, notebook computers, digital cameras, and camcorders, while large-capacity secondary batteries may be used, for example as power sources for driving motors, such as of hybrid vehicles or electric vehicles, and for power storage.

In general, the secondary battery includes an electrode assembly consisting of a positive electrode and a negative electrode, a case that accommodates the electrode assembly, a terminal part connected to the electrode assembly, a vent for discharging a gas (i.e., degassing) generated within the case, etc.

The above information disclosed in this Background section is only for enhancement of understanding of the background and therefore the information discussed in this Background section does not necessarily constitute prior art.

### SUMMARY

Aspects of some embodiments relate to a rivet terminal, a secondary battery including a rivet terminal, and a method of manufacturing a secondary battery. For example, aspects of some embodiments of the present disclosure relate to a secondary battery and to a secondary battery including a rivet terminal configured to have a hollow (or cavity) formed therein, to have a vent part provided in the hollow, and to have the vent part configured to be ruptured when a gas within the secondary battery is released so that degassing may be possible, and a method of manufacturing the same.

Various parts that perform their functions, such as a terminal part, an insulating part, and a vent part, may be connected to a cap assembly that is connected to the top of a case of a secondary battery. The number of such various parts may complicate the structure of the secondary battery and cause a rise in unit cost. Accordingly, aspects of some embodiments relate to the structure of a rivet terminal for a secondary battery that may relatively improve a unit cost and the simplification of management by relatively simplifying the structure of a cap assembly of the secondary battery.

However, the embodiments according to the present disclosure are not limited to the characteristics described above, and other aspects and features of embodiments according to the present disclosure, will be clearly understood by those skilled in the art from the description of the present disclosure below.

A rivet terminal according to some embodiments of the present disclosure may include a current carrying part connected to a terminal part of a secondary battery and configured to electrically connect a terminal plate of the secondary battery and a current collector within the secondary battery and to have a hollow formed therein, and a vent part provided in the hollow within the current carrying part and ruptured when a gas within the secondary battery is released.

According to some embodiments, a secondary battery may include a case configured to accommodate an electrode assembly, a terminal part connected to the electrode assembly, and a rivet terminal connected to the terminal part and configured to electrically connect a terminal plate of the terminal part and a current collector that connects the electrode assembly and the terminal part, to have a hollow formed therein, and to have a vent part provided in the hollow, wherein the vent part is ruptured when a gas within the secondary battery is released.

According to some embodiments, a method of manufacturing a secondary battery may include manufacturing an electrode assembly, manufacturing a case that accommodates the electrode assembly, manufacturing a terminal part connected to the electrode assembly, manufacturing a rivet terminal having a hollow formed therein and having a vent part provided in the hollow, and electrically connecting a terminal plate of the terminal part and a current collector that connects the electrode assembly and the terminal part by connecting the rivet terminal to the terminal part.

Some embodiments of the present disclosure, may include a vehicle including a secondary battery pack that is manufactured by using the secondary battery having the aforementioned construction.

According to some embodiments of the present disclosure, a rivet terminal is configured to have a hollow or cavity formed therein, to have a vent part provided in the hollow. According to some embodiments, the vent part may be configured to be ruptured to enable a gas within the secondary battery to be released so that degassing may be possible, and the function of the vent part may be combined with a rivet terminal. Accordingly, it may be possible to improve a unit cost and simplify management by simplifying the structure of the cap assembly of the secondary battery.

However, aspects of embodiments according to the present disclosure are not limited to those described above, and other aspects and features not mentioned will be more clearly understood by a person skilled in the art from the detailed description, described below.

### BRIEF DESCRIPTION OF THE DRAWINGS

The following drawings attached to the present specification illustrate aspects of some embodiments of the present disclosure, and further describe aspects and features of some embodiments of the present disclosure together with the detailed description of the present disclosure. Thus, embodiments according to the present disclosure should not be construed as being limited to the drawings:

FIG. 1A is a top perspective view of a prismatic secondary battery according to some embodiments of the present disclosure;

FIG. 1B is a cross-sectional view taken along the line I-I′ of FIG. 1A, according to some embodiments of the present disclosure;

FIG. 2 is an enlarged cross-sectional view illustrating a terminal part and peripheral part of a conventional secondary battery according to some embodiments of the present disclosure;

FIG. 3 is an enlarged cross-sectional view illustrating a vent part of the conventional secondary battery according to some embodiments of the present disclosure;

FIG. 4 is a diagram illustrating a form in which a rivet terminal according to some embodiments of the present disclosure has been applied to a secondary battery;

FIG. 5 is a cross-sectional view illustrating a rivet terminal according to some embodiments of the present disclosure;

FIG. 6A is a cross-sectional view illustrating a rivet terminal according to some embodiments of the present disclosure;

FIG. 6B is a plan view illustrating the rivet terminal according to some embodiments of the present disclosure;

FIG. 7 is an exemplary diagram of a secondary battery module in which secondary batteries have been arranged according to some embodiments of the present disclosure;

FIG. 8 is an exemplary diagram of a secondary battery pack including the secondary battery module illustrated in FIG. 7 according to some embodiments of the present disclosure; and

FIG. 9 is a conceptual view of a vehicle including the secondary battery pack illustrated in FIG. 8 according to some embodiments of the present disclosure.

### DETAILED DESCRIPTION

Hereinafter, aspects of some embodiments of the present disclosure will be described in more detail with reference to the accompanying drawings. Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

The type of secondary battery includes a coin type, a cylindrical type, a prismatic type, and a pouch type. Prior to a description of embodiments of the present disclosure, first, a prismatic secondary battery is roughly described because the present disclosure may be basically applied to the prismatic secondary battery.

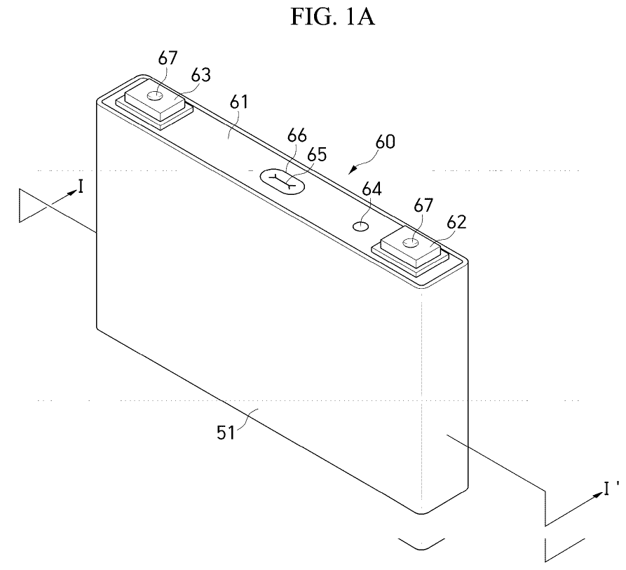

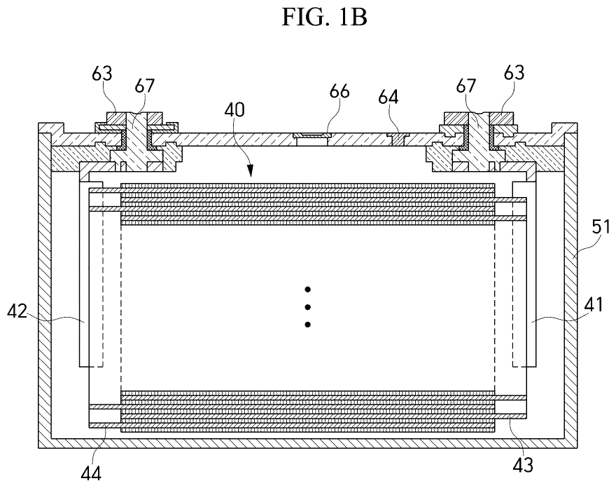

FIG. 1A is a top perspective view of a prismatic secondary battery, according to some embodiments of the present disclosure. FIG. 1B is a cross-sectional view taken along the line I-I′ of FIG. 1A, according to some embodiments of the present disclosure.

First, the external appearance of the prismatic secondary battery illustrated in FIG. 1A will be described in more detail.

A case 51 defines an overall appearance of the prismatic secondary battery, and may be made of a conductive metal, such as aluminum, aluminum alloy, or nickel-plated steel. In addition, the case 51 may provide a space or cavity for accommodating an electrode assembly therein.

A cap assembly 60 may include a cap plate 61 that covers the opening of the case 51. According to some embodiments, the case 51 and the cap plate 61 may be made of a conductive material. Here, a first terminal 62 and a second terminal 63 may be electrically connected to respective positive and negative (or negative and positive) electrodes inside the case, and may be installed to protrude outward through the cap plate 61.

The cap plate 61 may be equipped with an electrolyte injection port 64 formed to install a sealing plug (or seal pin), and a vent 66 formed with a notch 65. The vent 66 is for discharging gas generated inside the secondary battery.

With reference to FIG. 1B, the internal structure of the prismatic secondary battery and the coupling structure with the cap assembly 60 will be further described.

As shown in FIG. 1B, a prismatic secondary battery may include an electrode assembly 40, a first current collector 41, a first terminal 62, a second current collector 42, a second terminal 63, a case 51, and a cap assembly 60.

An electrode assembly 40 may be formed by winding or stacking a stack of a first electrode plate, a separator, and a second electrode plate, which are formed as thin plates or films. When the electrode assembly 40 is a wound stack, a winding axis may be parallel to the longitudinal direction (e.g., the y direction) of the case 51. According to some embodiments, the electrode assembly 40 is a stack type rather than a winding type, and the shape of the electrode assembly 40 is not limited in the present disclosure. In addition, the electrode assembly 40 may be a Z-stack electrode assembly in which a positive electrode plate and a negative electrode plate are inserted into both sides of a separator, which is then bent into a Z-stack. In addition, one or more electrode assemblies may be stacked such that long sides of the electrode assemblies are adjacent to each other and accommodated in the case, and the number of electrode assemblies in the case is not limited in the present disclosure. The first electrode plate of the electrode assembly may act as a negative electrode, and the second electrode plate may act as a positive electrode. According to some embodiments, the reverse is also possible.

The first electrode plate may be formed by applying a first electrode active material, such as graphite, carbon, or the like, to a first electrode current collector formed of a metal foil, such as copper, a copper alloy, nickel, a nickel alloy, or the like. The first electrode plate may include a first electrode tab 43 (e.g., a first uncoated portion) that is a region to which the first electrode active material is not applied. The first electrode tab 43 may act as a current flow path between the first electrode plate and the first current collector 41. According to some embodiments, when the first electrode plate is manufactured, the first electrode tab 43 is formed by being cut in advance to protrude to one side of the electrode assembly 40, or the first electrode tab 43 protrudes to one side of the electrode assembly 40 more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab 44 (e.g., a second uncoated portion) that is a region to which the second electrode active material is not applied. The second electrode tab 44 may act as a current flow path between the second electrode plate and the second current collector 42. According to some embodiments, the second electrode tab 44 may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

According to some embodiments, the first electrode tab 43 is located on the left side of the electrode assembly 40, and the second electrode tab 44 may be located on the right side of the electrode assembly 40. According to some embodiments, the first electrode tab 43 and the second electrode tab 44 are located on one side of the electrode assembly 40 in the same direction. Here, for convenience of description, the left and right sides are defined according to the secondary battery as oriented in FIG. 1, and the positions thereof may change when the secondary battery is rotated left and right or up and down.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate may be positioned at both ends (e.g., opposite ends) of the electrode assembly 40. According to some embodiments, the electrode assembly 40 is accommodated in the case 10 along with an electrolyte.

In addition, in the electrode assembly 40, the first current collector 41 and the second current collector 42 may be welded and connected to the first electrode tab 43 of the first electrode plate and the second electrode tab 44 of the second electrode plate exposed on both sides, respectively, to then be positioned thereat, respectively.

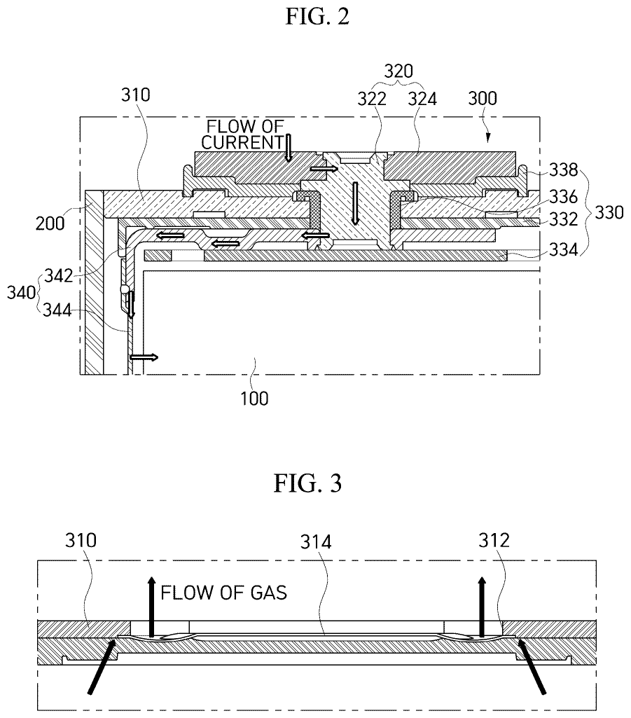

The first current collection part (or first current collector) 41 and the second current collection part (or second current collector) 42 may be connected to the first terminal 62 and the second terminal 63 described with reference to FIG. 2, through terminal pins 67, respectively. According to some embodiments, outer circumference surfaces of the terminal pins 67 may be subjected to screw processing, and may be fastened to the first terminal 62 and the second terminal 63, respectively, through screw coupling. However, the present disclosure is not limited to such an example, and the terminal pins 67 may be connected to the first terminal 62 and the second terminal 63 in a riveting way or by welding.

FIG. 2 is an enlarged cross-sectional view illustrating a terminal part and peripheral part of a conventional secondary battery according to some embodiments of the present disclosure. FIG. 3 is an enlarged cross-sectional view illustrating a vent part of the conventional secondary battery according to some embodiments of the present disclosure.

Referring to FIG. 2, the secondary battery may include an electrode assembly 100, a case 200 that accommodates the electrode assembly 100, and a cap assembly 300 connected to the case 200.

The cap assembly 300 may include a cap plate 310 connected to the case 200, a terminal part 320, a plurality of insulating members 330, and a current collection part 340.

The cap plate 310 may have an approximately rectangular plate form. The cap plate 310 may be formed of the same material as the case 200. Illustratively, the cap plate 310 may have a size corresponding to the internal size of an opening of the case 200. Furthermore, illustratively, the cap plate 310 may be connected to the case 200 by a method, such as laser welding. A terminal hole and groove for coupling with the terminal part 320, an injection hole, and a vent hole 312 for coupling with a vent 314 may be formed in the cap plate 310. The vent 314 may be connected to the vent hole 312 of the cap plate 310, which has been formed as illustrated in FIG. 3. The vent 314 may function to discharge a gas by being ruptured when internal pressure of the secondary battery rises. A common vent structure may be applied to the vent 314. When the vent 314 is ruptured, a flow of a gas may be from the inside of the secondary battery to the outside thereof so that the gas is released.

The terminal part 320 may include a terminal pin 322 and a terminal plate 324. The terminal part 320 may have a positive electrode or a negative electrode polarity, and may have the same structure as that of FIG. 2 although the terminal part 320 has any polarity.

The terminal pin 322 may have an approximately cylinder form, and may be electrically connected to the current collector 342 of the current collection part 340 and thus electrically connected to a first electrode plate or second electrode plate of the electrode assembly 100. As illustrated in FIG. 2, a flow of current from the terminal part 320 to the current collection part 340 may be formed through the terminal pin 322. In the state in which a pin insulating part 336 of the insulating member 330 has been inserted into the cap plate 310 upon manufacturing, a lower part of the terminal pin 322 may be inserted by sequentially penetrating the cap plate 310, an insulating plate 332, and a current collector 342. Thereafter, the terminal plate 324 may be seated in an upper part of the terminal pin 322, and may fix the terminal pin 322 and the terminal plate 324, and the terminal pin 322 and the current collector 342 by pressurizing and deforming the top and bottom of the terminal pin 322. Thereafter, the terminal pin 322 and the current collector 342 may be fixed by welding the bottom of the terminal pin 322 and a part of the bottom of the current collector 342, if necessary.

The terminal plate 324 may be disposed at the top of the terminal part 320. The outside and the secondary battery may be electrically connected by a conductive material. The terminal plate 324 may have an approximately plate form, and may be disposed in parallel to the top of the electrode assembly 100. A terminal hole into which the terminal pin 322 has been inserted therethrough may be formed in the terminal plate 324 therethrough. The terminal plate 324 may be seated in the terminal pin 322 in the state in which the terminal pin 322 has been inserted into the cap plate 310. Thereafter, the terminal plate 324 may be fixed to the terminal pin 322 in the state in which the terminal plate 324 has been connected to the terminal pin 322 by pressurizing and deforming the top of the terminal pin 322.

The insulating member 330 may include the insulating plate 332, a lower insulating part 334, the pin insulating part 336, and an upper insulating part 338. The insulating member may be entirely made of an insulating material and manufactured by using an injection method, for example.

The insulating plate 332 may have an approximately rectangular plate form. The insulating plate 332 may be closely attached to the bottom of the cap plate 310 to insulate the cap plate 310 and the electrode assembly 100. Furthermore, the insulating plate 332 may function to insulate a current collection structure to be described later and the cap plate 310. Accordingly, the insulating plate 332 may include a side that extends toward a lower part thereof along an edge thereof. The side may have a form in which the entire edge of the insulating plate 332 is connected, and may be formed partially only. A form of a plate surface or side of the insulating plate 332 may be different depending on forms of parts that need to be insulated. A through hole that corresponds to the location of the terminal hole of the cap plate 310 and the vent hole may be formed in the insulating plate 332. A part of the current collection part 340 and the lower insulating part 334 may be disposed under the insulating plate 332.

The lower insulating part 334 may be for the insulation of some components of the current collection part, and may have an approximately square plate form. The lower insulating part 334 may be provided as a pair. The pair of lower insulating parts may be disposed on the terminal part sides having a positive polarity and a negative polarity, respectively. Furthermore, the lower insulating part 334 may be disposed under the current collector 342, and may be formed to have a size capable of approximately covering the current collector 342. The lower insulating part 334 may be connected to the insulating plate 332 in the state in which the current collector 342 has been assembled.

The pin insulating part 336 may be for the insulation of the terminal pin 322 of the terminal part 320 and the cap plate 310, and may have an approximately cylindrical form.

The upper insulating part 338 may be disposed between the terminal plate 324 and the cap plate 310. The upper insulating part 338 may have a rectangular plate form corresponding to a form of the terminal plate 324. The upper insulating part 338 may be formed to be greater than the terminal plate 324, and may include a groove in which the terminal plate 324 is seated. A hole may be formed at a location on the upper insulating part 338, which corresponds to the terminal hole of the cap plate 310, by penetrating the upper insulating part 338. The terminal pin 322 may be disposed in the hole of the upper insulating part 338.

The current collection part 340 may function to electrically connect the first electrode plate or the second electrode plate and the terminal part 320. The current collection part 340 may include the current collector 342 that is electrically connected to the terminal part 320 and a sub-plate 344 that is electrically connected to the current collector 342 and the electrode assembly 100.

The current collector 342 may be made of a conductive material having a preset thickness, and may have a form in which the current collector has been bent approximately perpendicularly to the plate form. A through hole may be penetrated and formed at a location on the current collector 342, which corresponds to the terminal hole of the cap plate 310 and the through hole of the insulating plate 332. The terminal pin 322 may be inserted into the through hole of the current collector 342. An upper side may be defined as an upper part and a downward extended portion may be defined as a lower part on the basis of the bent portion of the current collector 342. A part of the upper part of the current collector 342 may come into contact with the bottom of the insulating plate 332. The bottom of the insulating plate 332 and the electrode assembly 100 may be insulated by the lower insulating part 334. An external surface of the lower part of the current collector 342 may come into contact with one side of the sub-plate 344. A connection between the current collector 342 and the sub-plate 344 may be performed by laser welding.

The sub-plate 344 may be made of a conductive material having a preset width and length, and may have an approximately plate form. One end (i.e., the top) of the sub-plate 344 may be brought into contact with the lower part of the current collector 342 and welded therewith. If a surface that belongs to a plate surface of the sub-plate 344 and that is directed toward the electrode assembly 100 is defined as an inside surface and a surface that belongs to the plate surface of the sub-plate 344 and that is directed toward a short-side part of the case 200 is defined as an outside surface, the electrode tap of the positive electrode or negative electrode of the electrode assembly 100 may be connected to the inside surface.

As described above, various parts that perform their functions may be connected to the cap assembly of the secondary battery. The cap assembly of the secondary battery may include the rivet terminal according to some embodiments of the present disclosure in order to prevent the complexity of the structure of the secondary battery and a rise in unit cost due to the various parts. Hereinafter, a rivet terminal according to some embodiments of the present disclosure and a secondary battery including the rivet terminal are described.

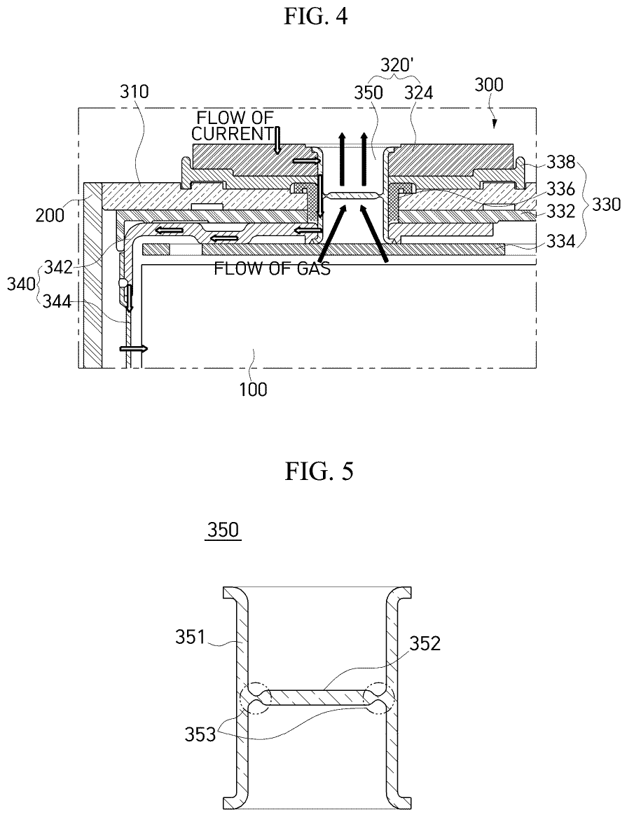

FIG. 4 is a diagram illustrating a form in which a rivet terminal according to some embodiments of the present disclosure has been applied to a secondary battery.

Referring to FIG. 4, a secondary battery including a rivet terminal 350 according to some embodiments of the present disclosure may include the rivet terminal 350 connected to a terminal part 320′, configured to electrically connect a terminal plate 324 of the terminal part 320′ and a current collector 342 that connects the electrode assembly 100 and the terminal part 320′ and to have a hollow cavity (or tunnel or tube) formed therein and have a vent part provided in the hollow cavity, and configured to have the vent part ruptured when a gas within the secondary battery is released.

As illustrated in FIG. 4, the rivet terminal 350 may replace the terminal pin 322 of the terminal part 320 illustrated in FIG. 2. In the secondary battery illustrated in FIG. 4, the rivet terminal 350 may play a role as the vent part. Accordingly, a vent hole may not be formed in the cap plate 310, and the cap assembly 300 may not separately include the vent part.

The rivet terminal 350 may have a form of a cylinder having a hollow (or cavity) approximately therein, and may be electrically connected to a first electrode plate or second electrode plate of the electrode assembly 100 by being electrically connected to a current collector 342 of a current collection part 340. In the state in which a pin insulating part 336 of an insulating member 330 has been inserted into a cap plate 310 upon manufacturing, a lower part of the rivet terminal 350 may be inserted by sequentially penetrating the cap plate 310, an insulating plate 332, and the current collector 342. Thereafter, the terminal plate 324 may be seated in an upper part of the rivet terminal 350. The rivet terminal 350 and the terminal plate 324, and the terminal pin 322 and the current collector 342 may be fixed by pressurizing and deforming the top and bottom of the rivet terminal 350. Thereafter, the rivet terminal 350 and the current collector 342 may be fixed by welding the bottom of the rivet terminal 350 and a part of the bottom of the current collector 342, according to some embodiments.

Furthermore, as the vent part formed in the hollow (or cavity) is ruptured when internal pressure of the secondary battery rises, the rivet terminal 350 may function to discharge a gas.

That is, as illustrated in FIG. 4, a flow of current from the terminal part 320′ to the current collection part 340 may be formed through the rivet terminal 350.

Furthermore, when the vent part formed in the hollow (or cavity) of the rivet terminal 350 is ruptured, a flow of a gas may be formed from the inside of the secondary battery to the outside thereof so that the gas can be released.

Accordingly, the secondary battery including the rivet terminal according to some embodiments of the present disclosure can relatively simplify a structure for the cap assembly of the secondary battery by combining the function of the vent part to a conventional rivet terminal. Accordingly, a unit cost of the secondary battery can be improved, and the management of the secondary battery can be relatively simplified.

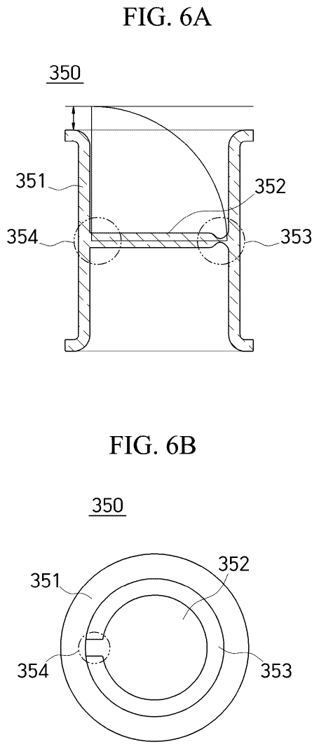

Hereinafter, embodiments in which the rivet terminal has been implemented are described in more detail with reference to FIGS. 5 to 6B.

FIG. 5 is a cross-sectional view illustrating the rivet terminal according to some embodiments of the present disclosure.

Referring to FIG. 5, the rivet terminal 350 according to some embodiments of the present disclosure may include a current carrying part 351 having a hollow (or cavity) formed therein and a vent part 352 provided in a hollow (or cavity) within the current carrying part 351. The current carrying part 351 may be formed of a conductive material and may be configured to enable current to flow through the rivet terminal 350. The cavity or hollow channel between interior edges of the current carrying part 351 may enable gas to flow through the cavity when the vent part 352 is ruptured. The vent part 352 may extend across the interior edges of the current carrying part 351 to prevent or block gas from flowing through the rivet terminal 350 when the vent part 352 is not ruptured according to some embodiments.

The current carrying part 351 may be connected to the terminal part 320′ of the secondary battery, and may electrically connect the terminal plate 324 of the secondary battery and the current collector 342 within the secondary battery. The current carrying part 351 may come into direct contact with the terminal plate 324 and the current collector 342 when the current carrying part 351 is connected to the terminal part 320′ so that a flow of current from the terminal part 320′ to the current collection part 340 can be formed.

The vent part 352 may be provided in the hollow (or cavity) within the current carrying part 351, and may function to be ruptured to enable a gas within the secondary battery to be released (e.g., when a gas pressure exceeds a threshold value or amount). According to some embodiments, the vent part 352 may be located at the center of the hollow (or cavity) up and down, but the upper and lower location of the vent part 352 may be adjusted according to various embodiments in order to adjust rupture pressure of the vent part 352.

The rivet terminal 350 may include a rupture induction part 353 that is formed at a connection portion of the current carrying part 351 and the vent part 352 and that facilitates the rupture of the vent part 352 when a gas within the secondary battery is released. The rupture induction part 353 may be formed at the connection portion of (e.g., a junction between) the current carrying part 351 and the vent part 352 at a smaller thickness than the vent part 352, and may enable the vent part 352 to be ruptured along the rupture induction part 353 by pressure in response to internal pressure of the secondary battery rising (e.g., above a set or predetermined threshold pressure value or amount).

The rupture induction part 353 has been illustrated as being entirely formed at the connection portion of the current carrying part 351 and the vent part 352 in FIG. 5, but may be formed in a part of the connection portion of the current carrying part 351 and the vent part 352. Such embodiments of the rivet terminal 350 is described in more detail hereinafter with reference to FIGS. 6A and 6B.

FIG. 6A is a cross-sectional view illustrating a rivet terminal according to some embodiments of the present disclosure. FIG. 6B is a plan view illustrating the rivet terminal according to some embodiments of the present disclosure.

Referring to FIGS. 6A and 6B, the rupture induction part 353 of the rivet terminal 350 according to some embodiments of the present disclosure may be formed in a part of the connection portion of the current carrying part 351 and the vent part 352.

The rivet terminal 350 according to some embodiments of the present disclosure may include a reinforcement part 354 that is formed in a portion that belongs to the connection portion of the current carrying part 351 and the vent part 352 except a portion where the rupture induction part 353 has been formed and that is formed to be thicker than the rupture induction part 353. The rivet terminal 350 according to some embodiments of the present disclosure may include the reinforcement part 354, and may prevent or reduce detachment (e.g., full detachment) of the vent part 352 from the current carrying part 351 by enabling only the rupture induction part 353 to be ruptured and the reinforcement part 354 to remain when the vent part 352 is ruptured. Accordingly, an impact on or damage to a peripheral device due to the full detachment of the vent part 352 can be prevented or reduced. The reinforcement part 354 may have a thickness that is equal to or similar to the thickness of the vent part 352, if necessary.

In this case, the vent part 352 may have a size that prevents or reduces exposure of one end of the vent part 352 over the top of the current carrying part 351 when the vent part 352 is ruptured. The reason for this is that if one end of the vent part 352 has a size that is exposed over the top of the current carrying part 351 when the vent part 352 is ruptured, the vent part 352 may not be fully opened because the vent part 352 is blocked by another device or structure over the top of the secondary battery upon rupture of the vent part 352 and degassing and as a result degassing may not be effectively performed.

However, if a marginal space is present between the secondary battery and another device or structure over the top of the secondary battery, the size of the vent part 352 may not need to have the aforementioned restriction.

A method of manufacturing a secondary battery including the rivet terminal 350 having the aforementioned structure is described.

According to some embodiments of the method of manufacturing a secondary battery, the electrode assembly 100 may be manufactured, the case 200 that accommodates the electrode assembly 100 may be manufactured, and the terminal part 320′ connected to the electrode assembly 100 may be manufactured. Furthermore, the rivet terminal 350 having the hollow (or cavity) formed therein and the vent part 352 provided in the hollow (or cavity) may be manufactured. In this case, the current carrying part 351 having the hollow (or cavity) formed therein may be formed. The rivet terminal 350 may be manufactured by providing the vent part 352 in the hollow (or cavity) within the current carrying part 351. Furthermore, the rupture induction part 353 that facilitates the rupture of the vent part 352 when a gas within the secondary battery is released may be formed in a part of or the entire connection portion of the current carrying part 351 and the vent part 352. Furthermore, the reinforcement part 354 that is thicker than the rupture induction part 353 may be formed in a portion that belongs to the connection portion of the current carrying part 351 and the vent part 352 except a portion where the rupture induction part 353 has been formed.

Thereafter, the terminal plate 324 and the current collector (or current collection part) 340 may be connected by connecting the rivet terminal 350 to the terminal part 320′.

Hereinafter, materials which may be used in a secondary battery according to some embodiments of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}0_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

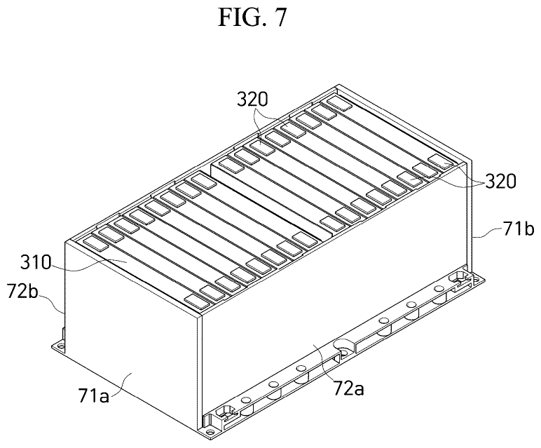

FIG. 7 is an exemplary diagram of a secondary battery module in which the secondary batteries illustrated in FIG. 4 have been arranged according to some embodiments of the present disclosure. The secondary battery module may be manufactured by arranging and connecting multiple secondary battery cells laterally and/or longitudinally as the capacity of a secondary battery for driving an electric vehicle is increased.

Multiple secondary batteries may be arranged in a space that is formed by a pair of end plates 71a and 71b that face each other and a pair of side plates 72a and 72b that face each other. A direction in which the secondary batteries are arranged and the number of secondary batteries may be designed so that desired voltage and current specifications are obtained.

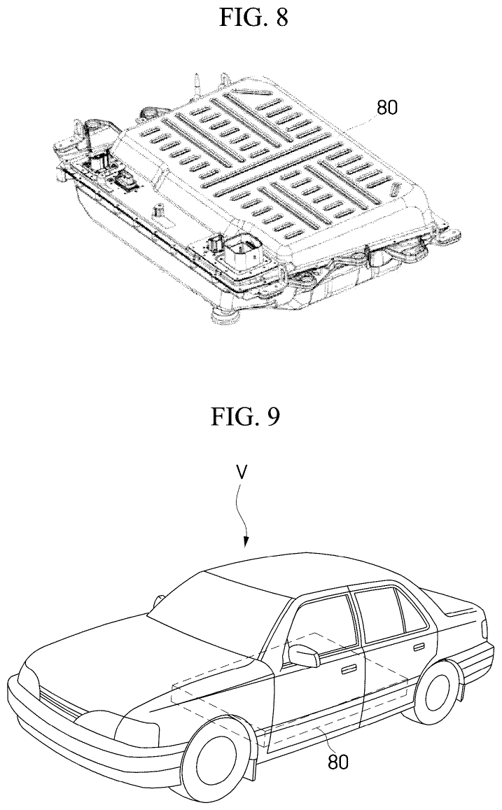

FIG. 8 is an exemplary diagram of a secondary battery pack 80 that has been constructed to apply the secondary battery module illustrated in FIG. 7 to an actual product (e.g., a vehicle).

The secondary battery pack may be manufactured by embedding multiple secondary battery modules in a pack housing having a form designed to mount the secondary battery pack on an actual product. The pack housing may include a fastening part that is necessary for the mounting of the secondary battery pack on the product and an electricity withdrawing part. Related elements, such as a bus bar for an electrical connection of secondary batteries, a cooling unit, and an external terminal, are not illustrated in FIG. 8, for convenience sake.

The secondary battery pack may be mounted on a vehicle. The vehicle may be an electric vehicle, a hybrid vehicle, or a plug-in hybrid vehicle, for example. The vehicle may include a four-wheel or two-wheel drive vehicle.

FIG. 9 is a diagram for describing a vehicle including the secondary battery pack illustrated in FIG. 8. FIG. 9 illustrates that the secondary battery pack 80 according to some embodiments of the present disclosure has been mounted on a lower part of the vehicle body of a vehicle V. The vehicle V may operate by being supplied with power from the secondary battery pack 80 according to some embodiments of the present disclosure.

Although aspects of some embodiments of the present disclosure have been described above in connection with the limited embodiments and drawings, the present disclosure is not limited to the embodiments. A person having ordinary knowledge in the art to which the present disclosure pertains may modify and change the present disclosure within the technical spirit of embodiments according to the present disclosure and the equivalent range of the following claims, and their equivalents.

### DESCRIPTION OF SOME OF THE REFERENCE NUMERALS

40: electrode assembly, 41: first current collection part, 42: second current collection part, 43: first electrode tap, 44: second electrode tap (second uncoated part), 51: case, 60: cap assembly, 61: cap plate, 62: first terminal, 63: second terminal, 64: electrolyte injection hole, 65: notch, 66: vent, 67: connection pole, 71a, 71b: end plate, 72a, 72b: side plate, 80: secondary battery pack, 100: electrode assembly, 200: case, 300: cap assembly, 320: terminal part, 322: terminal pin, 324: terminal plate, 330: insulating member, 332: insulating plate, 334: pin insulating part, 336: upper insulating part, 340: current collection part, 342: current collector, 344: sub-plate, 350: rivet terminal, 351: current carrying part, 352: vent part, 353: rupture induction part, 354: reinforcement part

What is claimed is:

1. A rivet terminal comprising:
a current carrying part connected to a terminal part of a secondary battery and configured to electrically connect a terminal plate of the secondary battery and a current collector within the secondary battery and having a cavity formed therein; and
a vent part in the cavity within the current carrying part and configured to be ruptured to enable a gas within the secondary battery to be released.

2. The rivet terminal as claimed in claim 1, further comprising a rupture induction part formed in a part of or an entirety of a connection portion of the current carrying part and the vent part and configured to facilitate rupturing of the vent part to enable the gas within the secondary battery to be released.

3. The rivet terminal as claimed in claim 2, further comprising a reinforcement part formed in a portion that belongs to the connection portion of the current carrying part and the vent part except a portion where the rupture induction part is located and formed to be thicker than the rupture induction part.

4. The rivet terminal as claimed in claim 1, wherein the vent part has a size that prevents one end of the vent part from being exposed over a top of the current carrying part when the vent part is ruptured.

5. A secondary battery comprising:
a case configured to accommodate an electrode assembly;
a terminal part connected to the electrode assembly; and
a rivet terminal connected to the terminal part and configured to electrically connect a terminal plate of the terminal part and a current collector connecting the electrode assembly and the terminal part, and having a cavity formed therein, and having a vent part in the cavity, wherein the vent part is configured to be ruptured to enable a gas within the secondary battery to be released.

6. The secondary battery as claimed in claim 5, wherein:
the rivet terminal further comprises a current carrying part connected to the terminal part and configured to electrically connect the terminal plate and the current collector and to have a cavity formed therein, and
the vent part is in the cavity within the current carrying part.

7. The secondary battery as claimed in claim 6, wherein the rivet terminal further comprises a rupture induction part in a part of or an entirety of a connection portion of the current carrying part and the vent part and configured to facilitate rupturing of the vent part to enable the gas within the secondary battery to be released.

8. The secondary battery as claimed in claim 7, wherein the rivet terminal further comprises a reinforcement part in a portion that belongs to a connection portion of the current carrying part and the vent part except a portion where the rupture induction part is formed and formed to be thicker than the rupture induction part.

9. The secondary battery as claimed in claim 6, wherein the vent part has a size that prevents one end of the vent part from being exposed over a top of the current carrying part when the vent part is ruptured.

10. The secondary battery as claimed in claim 5, wherein the secondary battery has a prismatic shape.

11. A method of manufacturing a secondary battery, comprising:
manufacturing an electrode assembly;
manufacturing a case accommodating the electrode assembly;
manufacturing a terminal part connected to the electrode assembly;
manufacturing a rivet terminal having a cavity formed therein and having a vent part in the cavity; and
electrically connecting a terminal plate of the terminal part and a current collector connecting the electrode assembly and the terminal part, by connecting the rivet terminal to the terminal part.

12. The method as claimed in claim 11, wherein the manufacturing of the rivet terminal comprises:
forming a current carrying part having a cavity formed therein; and
providing the vent part in the cavity within the current carrying part.

13. The method as claimed in claim 12, wherein the manufacturing of the rivet terminal further comprises forming a rupture induction part configured to facilitate a rupture of the vent part to enable a gas within the secondary battery to be released, in a part of or an entirety of a connection portion of the current carrying part and the vent part.

14. The method as claimed in claim 13, wherein the manufacturing of the rivet terminal further comprises forming a reinforcement part thicker than the rupture induction part in a portion that belongs to the connection portion of the current carrying part and the vent part except a portion where the rupture induction part has been formed.
